(19) United States
(12) Patent Application Publication
(10) Pub. No.: US 2008/0004933 A1
(43) Pub. Date: Jan. 3, 2008

(54) SYSTEM AND METHOD FOR PROVIDING DAILY AND LONG-TERM CONTACT, ALLOCATION AND FULL-TIME EQUIVALENT STAFF FORECASTING

(75) Inventor: Brian M. Gillespie, Austin, TX (US)

Correspondence Address: HITT GAINES P.C., P.O. BOX 832570, RICHARDSON, TX, 75083, US

(73) Assignee: Destination Excellence, Inc., Austin, TX (US)

(21) Appl. No.: 11/427,735

(22) Filed: Jun. 29, 2006

(51) Int. Cl. G06F 15/02

(52) U.S. Cl. 705/9

(57) ABSTRACT

A system for, and method of, providing daily and long-term contact, allocation and full-time equivalent staff forecasting. In one embodiment, the system includes: (1) a first module configured to generate a forecast of overall volume based on contacts disaggregated by type, (2) a second module associated with the first module and configured to simulate an allocation of contacts to skill groups and (3) a third module associated with the first and second modules and configured to generate a full-time equivalent staff forecast based on service time, staffing efficiency, unpaid time and the forecast of overall volume.

### COPYRIGHT NOTICE

This application contains material that is subject to copyright protection. The copyright owner has no objection to the facsimile reproduction for the patent disclosure by a person, as it appears in the Patent and Trademark Office patent files or records, but otherwise reserves all rights to the copyright whatsoever.

### TECHNICAL FIELD OF THE INVENTION

The invention is related, in general, to forecasting and, more specifically, to a system and method that employs statistical and other mathematical techniques to improve the forecasting of contacts (e.g., calls, e-mails, chat sessions and the like), contact allocations to skill groups and full-time equivalent (FTE) staff forecasting.

### BACKGROUND OF THE INVENTION

Contact (call) centers are centralized or distributed sites where inbound and outbound contacts (calls, e-mails, chat sessions and the like) are received and placed respectively. Contact centers include one or more skill groups that handle one or more contact types. Skill groups may be uniquely identified by the combination of contact type or mix of contacts that they handle and/or their geographic location.

Skill group staffing is determined by a number of factors, including contact volume, average handling time (AHT), service goals, service level, productive and unproductive (or “slippage”) time. Contact centers develop staffing plans through conventional workforce management (WFM) systems to provide intra-day forecasting and schedule planning.

WFM systems largely rely on user input for forecasted daily information including contact volume, AHT, productive and unproductive (slippage) time. The operational efficiency or effectiveness of the schedules developed from the WFM systems is highly dependent on the accuracy of the forecasted inputs.

Unfortunately, the forecasting process is made highly complex due to the various ways in which contact volumes may be forecasted, the difficulty in accurately interpreting historical contact data, the simulation of contact routing and the recognition of the interplay between various staff planning components.

In addition to daily forecasting needs, operational budgets for contact centers are often developed well in advance (six to 18 months) of the time period in which contacts are handled. To be most effective, budgets should reflect a series of operating assumptions that realistically simulate the operating environment in place at the time of the forecasted budget.

To provide optimal operating schedules and budgeting, a comprehensive contact forecasting and operational forecasting system for contact centers is needed to provide daily, weekly, monthly and annual forecasts. Accordingly, what is needed in the art is a better way to forecast contacts (e.g., calls, e-mails, chat sessions and the like), contact allocations to skill groups and FTE staffing.

### SUMMARY OF THE INVENTION

To address the above-discussed deficiencies of the prior art, the invention provides, in one aspect, a system for providing daily and long-term contact, allocation and full-time equivalent staff forecasting. In one embodiment, the system includes: (1) a first module configured to generate a forecast of overall volume based on contacts disaggregated by type, (2) a second module associated with the first module and configured to simulate an allocation of contacts to skill groups and (3) a third module associated with the first and second modules and configured to generate a full-time equivalent staff forecast based on service time, staffing efficiency, unpaid time and the forecast of overall volume.

In another aspect, the invention provides a method of providing daily and long-term contact, allocation and full-time equivalent staff forecasting. In one embodiment, the method includes: (1) generating a forecast of overall volume, service time and staffing efficiency based on contacts disaggregated by type and (2) generating a full-time equivalent staff forecast based on the forecast of overall volume, service time and staffing efficiency.

The foregoing has outlined preferred and alternative features of the invention so that those skilled in the pertinent art may better understand the detailed description of the invention that follows. Additional features of the invention will be described hereinafter that form the subject of the claims of the invention. Those skilled in the pertinent art should appreciate that they can readily use the disclosed conception and specific embodiment as a basis for designing or modifying other structures for carrying out the same purposes of the invention. Those skilled in the pertinent art should also realize that such equivalent constructions do not depart from the spirit and scope of the invention.

### BRIEF DESCRIPTION OF THE DRAWINGS

For a more complete understanding of the invention, reference is now made to the following descriptions taken in conjunction with the accompanying drawing, in which:

FIG. 1 is a graph of an example of performance curves exhibiting an occupancy/service level tradeoff associated with a skill group with specific operating parameters;

FIG. 2 is a graph of an example of various contact type mixes and how those mixes may contribute to overall contact volume over time;

FIG. 3 is a block diagram of one embodiment of a technique for creating an aggregated contact forecast carried out according to the principles of the invention;

FIG. 4 is chart illustrating the impact new hires have on AHT;

FIG. 5 is a block diagram of one embodiment of a technique for combining allocations of different contact types to determine productive time requirements, the impact of new hires on the staffing plan, the role of unproductive time and the use of overtime and undertime in determining staffing requirements;

FIG. 6 is a block diagram illustrating the interplay between the required and planned staff and the role of the unproductive time allocations (impacted by, impacting others and not impacted by or impacting) on one another, the role of the undertime and overtime plans on unproductive time and the assessment of service level and occupancy based on the staff plan;

FIG. 7 is a block diagram illustrating a system for contact forecasting constructed according to the principles of the invention; and

FIG. 8 is a block diagram illustrating a system for operations forecasting constructed according to the principles of the invention.

### DETAILED DESCRIPTION

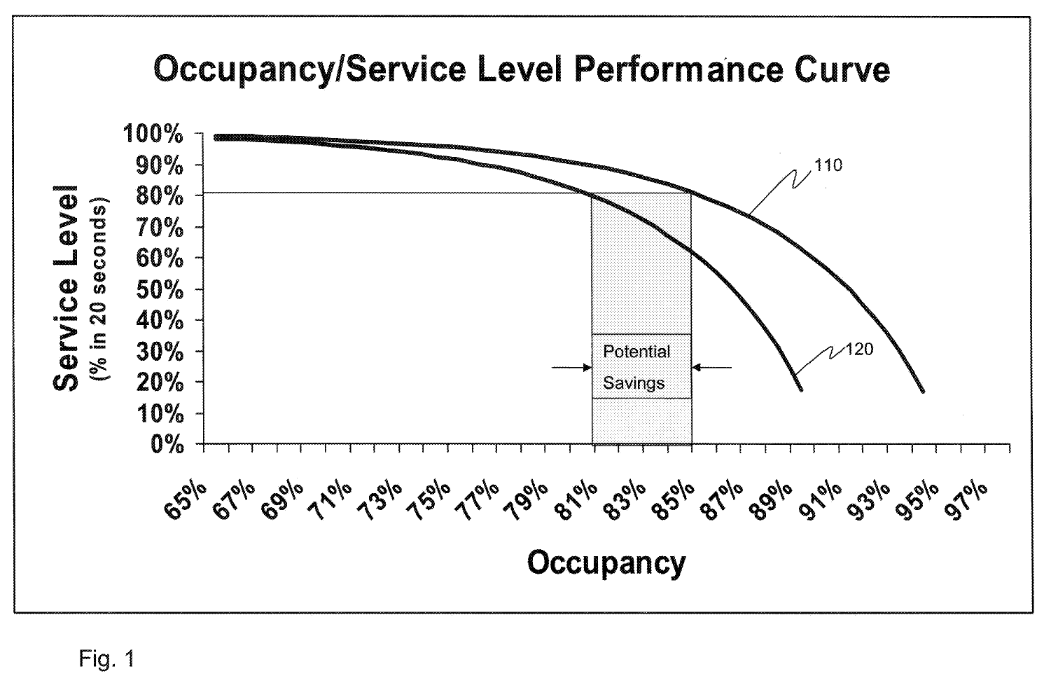

Before illustrating and describing exemplary systems and methods falling within the scope of the invention, some principles and observations underlying the issue of forecasting and staffing a contact center will be described. Accordingly, referring initially to FIG. 1, illustrated is a sample of performance curves (including an optimal performance curve 110 and an actual performance curve 120) exhibiting the occupancy/service level tradeoff associated for a skill group with the same specific operating parameters. The two performance curves 110, 120 represent different levels of forecasting and staffing efficiency performance. Higher performance results in cost savings due to higher occupancy of personnel (increased productivity) at the same service level. Users have the option of translating all improvements into occupancy gains, all improvements into service level gains or a mix of both. The systems and methods described below drive skill groups toward the optimal performance curve 110.

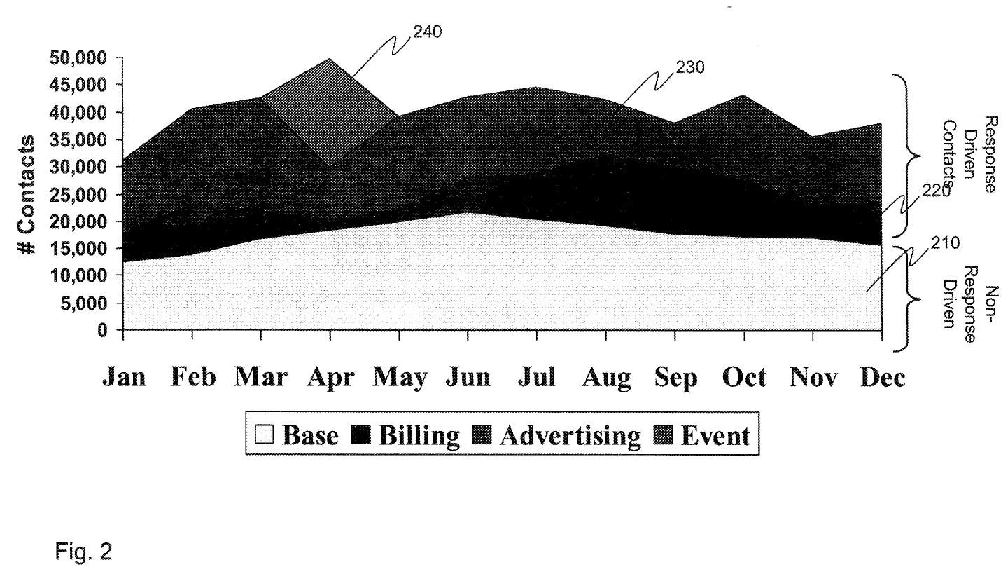

Turning now to FIG. 2, illustrated is a chart illustrating the aggregate of various contact types, how each type contributes to the overall (aggregate) contact volume differently each month. FIG. 2 illustrates a first contact type 210, a second contact type 220, a third contact type 230 and a fourth contact type 240. The four contact types 210, 220, 230, 240 aggregate to form an overall mix that is extremely difficult to forecast. However, as will become apparent, if the contact types 210, 220, 230, 240 are disaggregated and forecasted separately, a superior forecast almost certainly results.

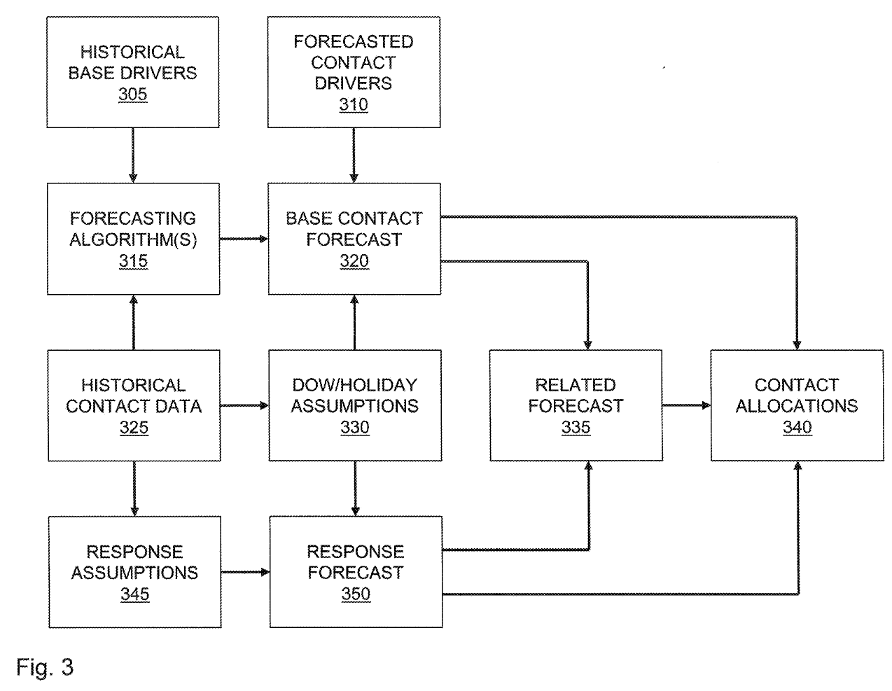

Turning now to FIG. 3, illustrated is the technique by which an aggregated contact forecast may be created. Historical base drivers 305 and historical contact data 325 are provided as inputs to one or more forecasting algorithms 315. The historical contact data 325 can also be used to develop day-of-week and holiday assumptions 330 and response assumptions 345, both of which can be, in turn, used as inputs to generate a response forecast 350. The output of the one or more forecasting algorithms 315, the day-of-week and holiday assumptions 350, along with forecasted contact drivers 310 are used to generate a base contact forecast 320. The base contact forecast 320 and the response forecast 350 can be used as the basis to generate a related forecast 335. Contact allocations 340 can be applied to base contact forecasts 330, response forecasts 350 and related forecasts 335 to determine contact volumes associated with various skill groups. FIG. 3 recognizes the inherent differences between responses, non-responses (base) and related forecasts utilizing historical data, making adjustments to historical information and using forward-looking assumptions to provide the most accurate contact forecast possible.

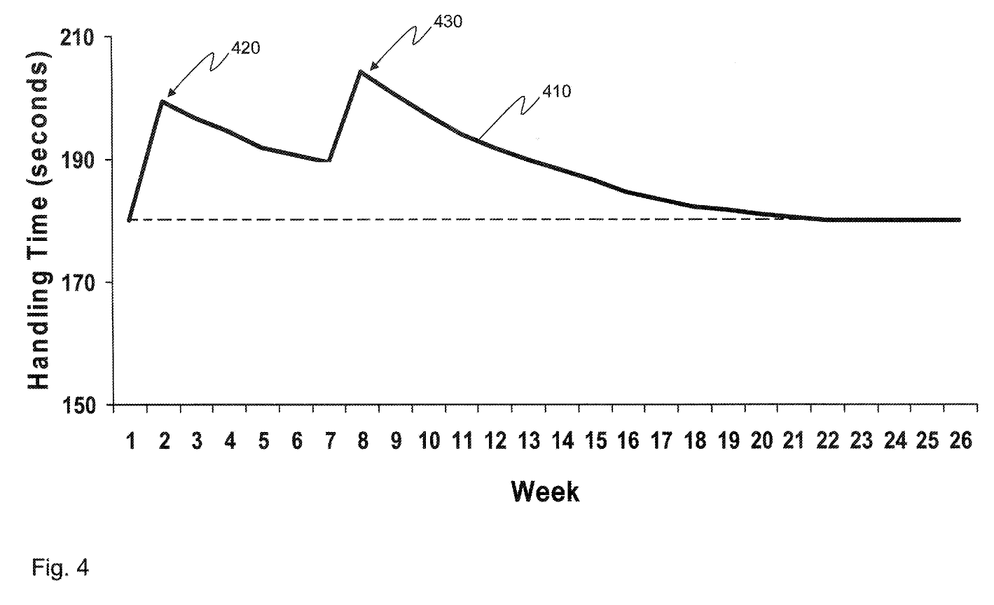

Turning now to FIG. 4, illustrated is a graph that shows the impact new hires have on AHT, supporting the need to make adjustments for new hires in AHT equations. A curve 410 illustrates the handling time over a period of 26 weeks. New hires are brought in during weeks 2 and 8. As a consequence, the skill group's handling time increases reflecting the higher handling time associated with new hires, as illustrated by points 420, 430 on the curve 410. The new hires eventually improve their contact handling skills, whereupon handling time eventually returns to a nominal 180-second time. FIG. 4 illustrates that the recovery of handling time can be slow, sometimes taking many months, making the accurate forecasting of handling time imperative in the forecasting process.

Various embodiments of the invention that provide contact, allocation and full-time equivalent (FTE staff) forecasting for contact centers using historical data, a set of forward-looking assumptions or both will now be described. These embodiments allow users to enter historical contact data, which can be disaggregated and used in forecasting future contact volume. Contact forecasts can be (1) based on responses to a company's communication efforts (2) based on a series of user-defined contact drivers applied against adjusted contact volumes using a series of analytical techniques or (3) based on a response or base forecast. Contacts can be allocated to established skill groups on a one-to-one, one-to-many, many-to-one or many-to-many relationship as defined by the user. Novel contact allocation techniques allow users to apply varying service level, handling time and learning curves to contact types assigned to the same skill group. Algorithms are used accurately to calculate online (contacts with service level requirements) and offline (contacts without service level requirements) productive staffing requirements to handle the workload. In certain embodiments, contact forecasts and contact allocation schemes are used to provide a foundation for the FTE staff forecast. In certain embodiments, users enter staffing and unproductive time assumptions to create a complete FTE staff forecast. In other embodiments, unproductive time assumptions may be listed as paid or unpaid and designated as impacting, not impacting or being impacted by other unproductive categories. In some embodiments, unproductive time categories are iteratively calculated. Overtime and undertime requirements may be automatically generated to meet user specifications. The resulting output may include contact volumes, average handling time, service levels and staffing efficiency at the contact type, skill group or summary levels. Productive staffing requirements, unproductive staffing requirements, total staffing requirements and adjustments to a staff plan may also be provided at the shift type, skill group or summary level to give user information on operational performance.

Various embodiments disclosed herein may be conceptually divided into three parts. The first part allows contact forecasting. Contact forecasting provides a way by which users can disaggregate forecasts into their most logical parts and forecast future volumes based on contact drivers, response mechanisms or other factors and then re-aggregate contact forecasts based on a defined allocation methodology.

The second part provides users the ability to simulate contact allocations to designated skill groups. Users may designate contacts as being allocated virtually (treating geographically or logically separate skill groups as if they were one) or discretely (treating each skill group as a separate, independent entity). The allocation technique also allows users to define allocations on a standard set of predefined allocation percentages or allow allocations to change allocations daily based on a staff plan.

Certain embodiments of the allocation technique maintain contacts as separate entities and blend multiple contacts assigned to the same skill group to produce an accurate set of parameters for the calculation of required productive staff necessary to meet various operational criteria.

The third part takes the individual contact allocation profiles (service time, service goal, handling time, learning curve, forecasting and staffing efficiency) and creates a blended profile to produce the productive hours required. Productive hour requirements are added to unproductive hours required to determine the total staff required for a skill group. The unproductive time required may automatically adjusts itself, based on user parameters, to recognize the interdependence of various unproductive (slippage) categories to provide a more accurate unproductive staffing requirement.

Productive and unproductive time requirements may be added together to create staffing requirements. Users may designate minimum overtime and undertime plans on a daily basis. When compared to the staff plan, users may opt to have the system automatically add undertime and overtime (above the minimum designated by the user) to balance the required and planned staff. Users may balance to an overstaffed level (having more staff than required) or an understaffed level (having less staff than required).

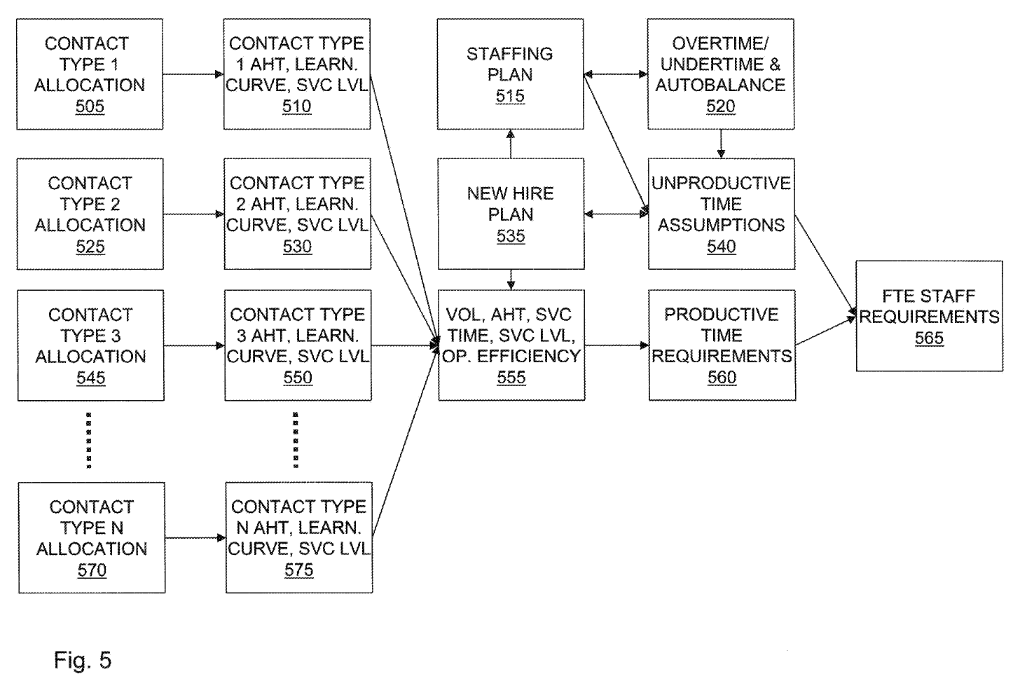

FIG. 5 provides a schematic of one embodiment of a system constructed according to the principles of the invention. The system combines allocations of different contact types previously forecasted to determine productive time requirements, the impact of new hires on the staffing plan, the role of unproductive time, and the use of overtime and undertime in determining staffing requirements.

In FIG. 5, contacts are first disaggregated by type consistent with the schematic provided in FIG. 3. FIG. 5 illustrates a disaggregation of N types of contacts and the Contact Type Allocation schemes associated with each. A contact type 1 allocation 505 determines the contact type 1 contact volume assigned to a specific skill group. At the skill group, contact type 1 is assigned an AHT, learning curve and service level (including a staffing efficiency) in a module 510. Likewise, a contact type 2 allocation 525, a contact type 3 allocation 545 and a contact type N allocation 570 are used to generate corresponding contact volumes to specific skill groups (which may overlap with one another). Within each associated skill group, contact type 2 AHT, learning curve and service level in a module 530, contact type 3 AHT, learning curve and service level in a module 550 and contact type N AHT, learning curve and service level in a module 575. The modules 510, 530, 550, 575, along with a new hire plan developed in a module 535, are used to forecast a blended volume, AHT, service time, service level and staffing efficiency in a module 555. The new hire plan module 535 also factors into an overall staffing plan module 515 that interacts with an overtime/undertime and autobalancing function module 520 and unproductive time assumptions module 540. The forecasted blended volume, AHT, service time, service level and staffing efficiency module 555 are used to generate productive time requirements module 560 which, in combination with the unproductive time assumptions module 540, are used to generate FTE staff requirements module 565. Further description of this system will be set forth below.

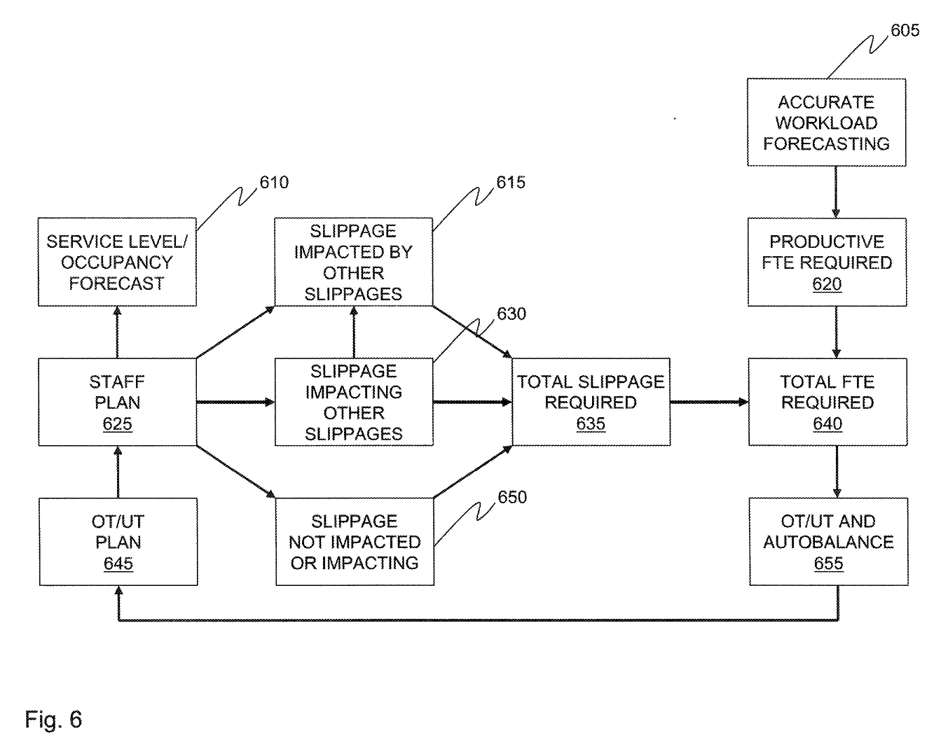

Turning now to FIG. 6, illustrated is the interplay between the required and planned staff and the role of the unproductive time allocations (impacted by, impacting others and not impacted by or impacting) on one another, the role of the undertime and overtime plans on unproductive time and the assessment of service level and occupancy based on the staff plan. Accurate workload (contact, AHT, service level, staffing efficiency) forecasting 605 yields productive FTE required 620 which, in turn, factors into total FTE required 640. The total FTE required 640 is provided as an input to the overtime/undertime and autobalance function 655 provides additional input to the overtime/undertime plan 645 to determine the total overtime/undertime required. The overtime/undertime plan 645 is used as input to the staff plan 625, which is then used as an input to generate a service level/occupancy forecast 610, the unproductive time (slippage) impacted by other slippages 615, the unproductive time (slippage) impacting other slippages 630 and the unproductive time (slippages) neither impacted nor impacting 650. (The slippage impacting other slippages 630 factors into the slippage impacted by other slippages 615). The slippage impacted by other slippages 615, slippage impacting other slippages 630 and slippages neither impacted nor impacting 650, taken together, yield total slippage (unproductive time) required 635, which, in turn, impacts the total FTE required 640. It is apparent from a review of FIG. 6 that an iterative approach is highly desirable to settle the total slippage required 635 with the total FTE required 640, as each impacts the other.

One embodiment of a system for performing contact forecasting, contact allocation simulation and FTE staff forecasting for contact centers to be used as input to a WFM system will now be described. The system increases the accuracy of daily, weekly, monthly and annual forecasts to allow contact centers to operate more effectively, either by reducing operating costs, increasing service or a combination. The system can accept manual data entry of historical data or automated entry of historical data to produce forecasts. The output of the system may be manually entered or fed automatically into a WFM system.

The following is a description of the various functions within the exemplary system.

The system has three logical parts: contact forecasting, contact allocation simulation and FTE staff forecasting. The first part, contact forecasting, can operate independent of the other two. In other words, a contact forecast can be developed without having to allocate those contacts or develop a staffing forecast. The allocation simulation does require a contact forecast be completed. The staffing forecast requires that both the contact forecast and contact simulation be completed.

Contact Forecasting

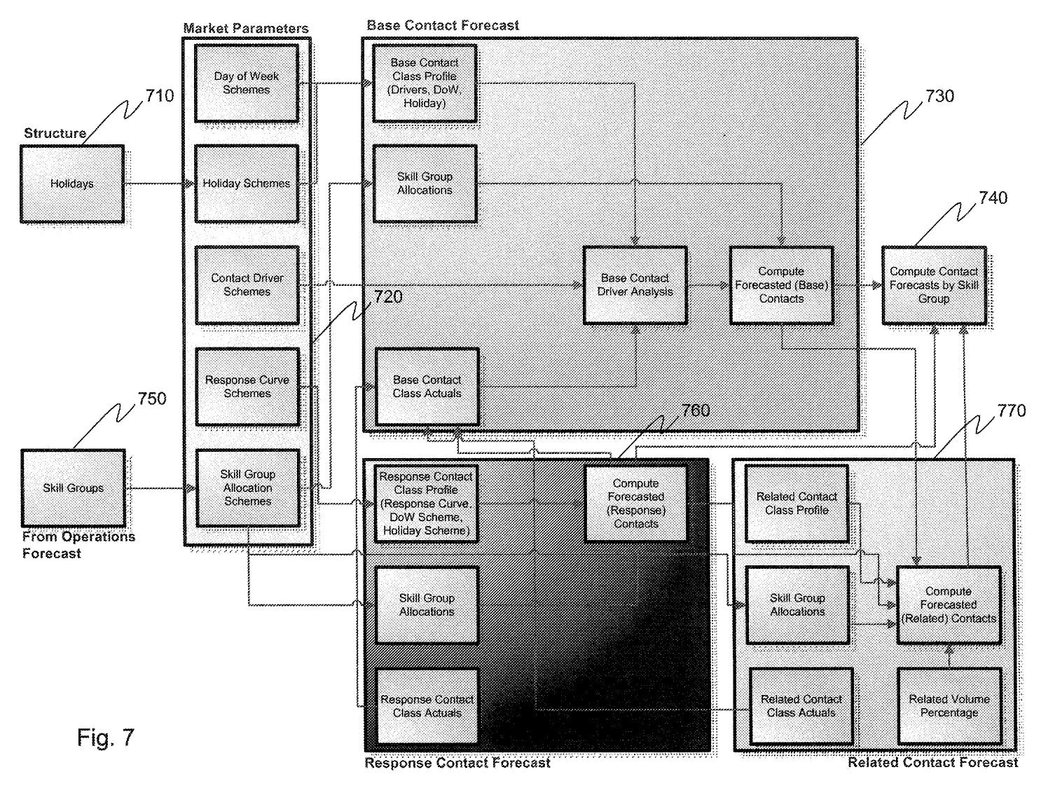

Turning now to FIG. 7, illustrated is the interdependent relationship between the various calculations conducted in the contact forecast. The contact forecast has in it an allocation scheme that is dependent on the operations forecast, and that the operations forecast is dependent on the contact forecast as well. A contact forecast can be generated without an operations forecast, but a contact forecast is required to generate an operations forecast. A holiday structure 710 and skill groups structure 750 are used as inputs to market parameters 720. The market parameters 720 (excluding response curve schemes) are provided to a base contact forecast module 730. The market parameters 720 (excluding contact driver schemes) are provided to a response contact forecast module 760. The response contact forecast module 760 and related contact forecast module 770 provide inputs to the base contact forecast module 730 (as a way to adjust historical data). The base forecast module 730 and the response forecast module 760 provide inputs to the related contact forecast module. The base contact forecast module 730, the response forecast module 760 and the related contact forecast module 770 provide data to enable contact forecasts to be generated in total or by skill group, indicated by a block 740.

The contact forecast has a set of contact parameters (called schemes and located within the market parameters 720) that can be established and then applied to an individual forecast (forecasts can share a set of assumptions, or schemes, if desired). Schemes are set at the global level to ensure consistency in assumptions and applications, and can be controlled by the system administrator, if desired. (In such a case, users would not be able to change market parameters (global assumptions), but only select from a list predetermined by the system administrator.

Three general contact forecast types exist in the illustrated embodiment: base, response, and related. Base contact forecasts (see the base contact forecast module 730) use historical contact data (which can be adjusted for other contact types if only an aggregate contact volume is available) which is adjusted based on retry rates, holidays, and days of week (if applicable) to generate equivalent weekly contacts. Equivalent weekly contacts are then applied against contact drivers to determine the relationship between them. If the user selects seasonal analysis, the system determines those factors as well. These relationships are then applied against driver forecasts, along with day of week and holiday factors, to generate the base contact forecast.

Response contact forecasts (see the response contact forecast module 760) are generated based on specific activities undertaken by the company (e.g., billing, advertising, public relations) and are expected to generate responses due to that activity. Response forecasts require users to define a response curve (and a day of week scheme, if a weekly response curve is used), volume (e.g., billing drops), a response rate, and days delayed (lag in the time between the projected volume and first contact).

Related forecasts (see the related contact forecast module 770) use the output of the base and response contact forecasts to create a forecast that is a percentage of the designated forecast.

The system has the ability to develop base forecasts using historical data or, for companies without historical data, user-entered parameters. The system recognizes that a contact forecast is normally an aggregate of individual contact forecasts. The system provides users with the ability to develop individual contact forecasts, apply the forecasting technique most appropriate to that individual forecast and combine individual forecasts as it best simulates the specific business model.

Contact Forecast Types

The system provides users the ability to generate forecasts using one of three approaches:

Response Contact Forecast. Response contact forecasts are generally described as forecasts for specific activities undertaken by a company that causes contacts to be generated. These activities could include programs with the specific purpose of the generating contacts (e.g., marketing campaigns) or activities that naturally result in customer inquiries (e.g., billing).

Base Contact Forecast. Base contact forecasts fall into two categories. The first category is where a company has historical contact and driver data and forecasted driver data from which a forecast can be generated. Examples of contact driver data may include the number of customers initiating service, the number of customers disconnecting service and the number of customers at the beginning or end of a defined period. Historical contact data requires that users (1) have historical data on these types of contacts, (2) have historical data on total contact volume other contact types to disaggregate volumes or (3) have historical data on total contact volume and have historical forecasts on other contact types to disaggregate contact volumes. The second category of base forecasts is where the company has no historical data available (either it has not been maintained, or the application is new to the company). This approach requires a company provide forecasted drivers and enter manual factors to generate a base forecast.

Related Contact Forecast. A related forecast is one that is generated by taking a response or base contact forecast and multiplying it by a factor. Generating a related contact forecast requires that its associated response or base contact forecast has already been generated.

Before a response or base contact forecast can be generated, users establish a set of assumptions to be applied to a forecast. These assumptions are included in market parameters.

Market Parameters

The system uses a set of global assumptions, or schemes, that can be applied across a number of contact forecasts called market parameters. Schemes are established at the market parameter level to both ensure consistency between forecast assumptions and reduce duplicate data entry for forecasts.

Market parameters include day-of-week schemes, holiday schemes, contact driver schemes, response curve schemes and contact allocation schemes. Market parameter schemes are applied by users when generating a market forecast through a menu list of available schemes. The system allows users to apply the same scheme across multiple forecasts, if desired. The use of market parameter schemes follows:

Day-Of-Week Schemes. Each day-of-week scheme provides a profile of how forecasted weekly contacts are distributed between the days within a week. Base forecasts always generate weekly forecasts and a day-of-week scheme is required to generate a daily forecast. Response contact forecasts can be developed using daily or weekly response curves. Weekly response curves require a day-of-week scheme be assigned.

Holiday Schemes. Holiday schemes are optional, in that they are not required to generate a forecast, but can be applied by the user to increase forecast accuracy. Holiday schemes are used to adjust forecasted contact volumes on user-specified days to reflect the impact of specific days on regularly forecasted contact volumes. Holiday dates are set up in the options menu (defined as occurring on a specific date, a recurring day of the year or a floating date). Holiday schemes use selected dates and users provide the number of days before and after the holiday date that will impact forecasted contact volume. Users enter the percent of normal contact volume that is expected on that date (e.g., a ninety percent entry would generate ten percent lower contact volume than normally anticipated and a one-hundred ten percent entry would generate ten percent more contact volume than normally anticipated). The value of holiday schemes is that they allow the user to establish a scheme once and have it apply to all future defined periods.

Contact Driver Schemes. Used only for base contact forecasts, contact driver schemes provide the basis for the analysis that associates historical base contact volume against potential contact drivers, and for generating future base forecasts using designated contact drivers and their associated volumes. Potential contact drivers and their associated volumes (e.g., customers and number of customers by time period), are entered here for future use in the algorithm that determines the linkage between based contact volumes and base contact drivers. Contact drivers are designated as beginning of period, end of period or for the period to provide a more accurate statistical analysis.

Response Curve Schemes. Response curve schemes are required to establish a response contact forecast. A response curve scheme defines how contact responses are distributed over a period of time. Response curve schemes are designated as either daily or weekly (weekly requires a later association with a day-of-week scheme) along with the length of the response curve (number of days or weeks). Each time period (day or week) has an associated percentage with the sum of the percentages across all time periods equaling one hundred percent. A response curve scheme is later associated with a response contact forecast along with a response rate, delay in responses (if any) and the volume (impressions or pieces) that are being created in the market.

Skill Group Allocation Schemes. Skill group allocation schemes are required only if the system is to be used to project the volume of contacts into specific skill groups or skill group staffing (FTE staff) forecasts. Skill group allocation schemes are used to define the number of and in what manner contacts are to be allocated to established skill groups (a skill group is a location in which contacts are assigned and will be explained in more detail in the Operations Forecast section). The number of contacts assigned to a skill group can be determined by a straight percentage (a custom allocation scheme where this percentage may vary both by day and time frame) or based on the staffing models of the assigned skill groups.

Schemes are defined as named items with one or more profiles (start date and detail combination) within them. A scheme with a single profile contains one start date with the necessary detail in that profile (e.g., a day-of-week scheme requires that the distribution percentage by day be filled in for all seven days in a week). A scheme with more than one profile has a list of profiles, each with a unique start date and associated detail. Users enter in a new profile (start date and details) in a scheme any time they wish to reflect new detail to be associated with that scheme for a period of time.

For example, if a user were to establish a day-of-week scheme they would begin by entering in the day-of-week scheme name, a profile name, a start date for the profile (e.g., Jan. 1, 2004) and the details of the profile (percentage of volume associated with each day). Adding a second profile can be accomplished by entering a new start date (e.g., Jan. 1, 2006) and adding the necessary details to the profile. A forecast using that day-of-week scheme uses the first profile from Jan. 1, 2004 through Dec. 31, 2005 and the second profile from Jan. 1, 2006 forward.

The system uses start dates to both define when a scheme, profile or some other application is to begin, as well as when the previous profile is scheduled to end. In the previous example, when a user inputs the second profile's start date of Jan. 1, 2006, the system automatically creates an end date for the previous profile of the new start date minus one day (Dec. 31, 2005). This approach minimizes user input and ensures a continuous stream of assumptions without gaps in those assumptions.

Generating Response Contact Forecasts

Response contact forecasts require that one or more response curve schemes have been defined. If any response curve scheme is defined as having a weekly response curve, then at least one day-of-week scheme should also be defined. These two schemes are associated with the forecast along with a holiday scheme, if applicable.

Users have the ability to define a response contact type as fixed or variable. A fixed response contact type is characterized as having the same audience size (volume of activity, such as direct mail pieces or advertising impressions), response rate and a delay in response for each day over a defined period. A custom response contact type is characterized by one or more inputs of audience size, response rate and delay in response varies over a designated time period. The defined time period is the time period over which company response activities take place. Forecasted responses may occur after the response activity period end date has passed, based on the length of the response curve.

Users also have the ability to define the response contacts forecasted as being handled on a discrete or virtual basis. The designation of discrete contact routing tells the system that contacts are routed to a skill group that does not operate on a virtual basis or does not route in a way to balance workload between assigned skill groups. Virtual contact routing indicates to the system that skill groups handling this contact type should be treated as if they are one large skill group.

The contact handling option is only relevant when more than one skill group is later assigned to handle these types of contacts. Selection of a contact handling technique prior to the assignment of a skill group or when only one skill group is assigned, does not impact later calculations.

The system calculates responses by taking the volume of the company activity for the time period, multiplying it by the response rate for that time period, pushing the responses out to account for the designed delayed period, distributing responses according to the response curve scheme, day-of-week scheme and holiday scheme, as applicable. Calculations are performed each day where audience size is greater than zero. Days receiving responses from multiple sources sum the responses to determine the total response forecasted contact volume for that day.

For example, a company may have two direct mailings, occurring on Wednesday, February 1^{st} and Thursday, February 2^{nd}. The February 1^{st} volume is 10,000 pieces and the February 2^{nd} volume is 20,000 pieces. Each piece has a two-day delay, a response rate of two percent and uses a daily response curve of two days that has a first day response of 75% and the second day response of 25%. The first day of response is February 3^{rd} (February 1^{st} plus two days). The forecast for February 3^{rd} is 150 responses (10,000 times two percent times 75%).

The forecast for February 4^{th} recognizes response forecasts from both days. The forecast for February 4^{th} is 350 responses, 50 from the February 1^{st} volume (10,000 times two percent times 25%) and 300 from the February 2^{nd} volume (20,000 times two percent times 75%).

The system overlays multiple volumes on various days, with varying sizes, response rates and days delayed to create an accurate response contact forecast. Response contact forecasts can also be summed together, as designated by the user.

Users may, but are not required, to enter historical response volumes by forecast in the system. Historical response volumes can be used to run comparative reports. They can also be used to make adjustments to based contact actual volumes, depending on the entry mode and options selected by the user.

Generating Base Contact Forecasts

Base contact forecasts are more complex in that they require the application of sophisticated analytical techniques applied against a potentially large number of variables to determine a best-fit forecast. To generate a base contact forecast, a user should define at least one day-of-week scheme and one contact driver scheme. They may also define more than one of these schemes to be applied over varying time periods. None, one or more than one holiday scheme may also be defined.

Users are allowed to select the contact drivers to be considered when performing based contact analysis. A list of drivers previously input in the contact driver schemes is provided to the user and the user selects which contact driver(s) they would like included in their analysis. Users must select at least one driver to generate a base contact forecast, however, users are not required to select more than one driver for a forecast. Drivers may be shared by more than one forecast and some drivers may not be used by any forecast.

Users also enter historical offered and answered contact volumes on a daily basis over a user-designated time period. Users designate the historical contact volume entered as being associated with base contacts only or being for multiple contact types (since many contact centers do not track actual contact volumes in the same way they forecast, this feature avoids potential issues with disparate techniques). If the volumes entered are for base contacts only, no additional adjustments to the data are required.

If the actual volume information entered is for multiple contact types (aggregate entry), the system allows users to select the contact types to be excluded from the amount entered to generate actual base contact volumes. If a user has entered actual volumes for other contact types, the system deducts these volumes from the total entered under actual base contact volume to generate an adjusted actual volume number. If no actual volume has been entered for other contact types, the system uses the system-generated forecast volumes for those contact types over the designated time periods as a substitute for actual contact volumes to calculate the adjusted historical base volume.

The system takes the historical offered and answered base contact volumes and determines the number of unique contacts (equivalent contacts) generated based on a retry rate entered by the user. Equivalent contacts become a component of the base contact forecast analysis.

Historical base volume information is available to the user, at their option, for inclusion future base contact volume analysis (meaning the user may exclude time periods that are not to be considered in the analysis). Before the based contact analysis can be run, users must select the time period association between the drivers and historical contact volume. They must also designate if seasonality is to be applied to the analysis. Potential non-seasonal combinations (driver-to-contact designation) include month-to-month and week-to-week. Seasonal associations include year-to-month and year-to-week. If contact periods are defined as a month, the system automatically adjusts monthly historical contact information to weekly data, adjusting for the number and types of days in a month, as well as any holidays in effect in that month.

Users are also required to select a day-of-week scheme (since a weekly forecast is the basis for the association described previously) that has been previously entered into the system. A holiday scheme may also be selected, but one is not required to create a base contact forecast.

The system initially assumes that all historical volumes entered over various time periods are used. Users may deselect time periods to be removed from consideration in the analysis.

To conduct a base volume forecast, users have the option to: (1) allow the system to automatically analyze and select the contact drivers and determine the factors that create a best fit base contact forecast, (2) manually select the drivers to use in the analysis and allow the system to generate the factors used in a base contact forecast or (3) manually select the drivers and directly enter forecasting factors to generate a base contact forecast. In the first two techniques used, the system uses multivariate regression analysis (MVA) to determine the historical relationship between base contact volume (with adjustments as previously described) and base contact drivers. Users can review the output of this analysis and make adjustments to historical contact data, base contact drivers and whether to use a y-intercept of 0 as an element in the analysis. Once a user is satisfied with the output of the system, the results are saved and used for the base contact forecast for a specified time period.

Users can designate specific periods for which a particular base contact analysis is applied. For example, if a user finds that changes in technology create changes in customer behavior, they can generate a new analysis using the start date methodology previously described. The historical analysis period may overlap with other analyses, but the start date applied to the new analysis ensures that the forecast is unique (i.e., no two forecasting techniques may overlap for the same forecast). A user can view the accuracy of the historical forecast while maintaining a unique forecast period.

As an example, assume a user has created a month-to-month non-seasonal analysis in the contact driver scheme and has created three potential contact drivers. These drivers are the number of customers, the number of new installations and the number of deactivations. Activations and deactivations have been defined as fore the period numbers while the number of customers have been defined as end of period numbers.

The user has entered historical information for the drivers for each month from January 2004 to December 2005 (24 months in total). They have also input forecasted information on the same drivers from January 2006 to December 2006. All three potential drivers have been selected to be available for analysis.

A day-of-week scheme and a holiday scheme have been selected. Contact handling is designated as virtual, although no skill groups have yet been assigned.

The user has entered daily historical daily contact information for offered and answered contacts from January 2004 to December 2005. A 75% retry rate has also been entered. The user has designated these contacts as being entered in total aggregate and has designated all response forecasts to be subtracted from the total to calculate the base contact volume. Since no actual data are available for response forecasts, the system uses the response forecasted data available between January 2004 and December 2005.

The system calculates the equivalent monthly contacts for base volume by first calculating equivalent total contacts using the retry rate entered by the user. Upon completing this calculation on a daily basis, the system then subtracts the designated daily response forecasted contacts for each day to attain a daily base equivalent contact number. Equivalent contact numbers are summed for each month and are translated into equivalent weekly contacts to remove noise for the analysis. This is done by taking the monthly number and dividing it by the sum of every day's day-of-week scheme percentage times any active holiday factor for that day over the entire month.

The user is now ready to proceed with the base contact analysis forecast. When opening the analysis screen, the user creates a name for their analysis and a start date the analysis is to be applied. The months of historical contact volume entered default to having all being considered for the analysis. The user may de-select any month, if necessary. De-selection is advisable if any month's data are incomplete (days or busy hour data are missing) or is considered an outlier (due to outside forces such as a disaster). If any contact driver has been designated as beginning of period or end of period, any non-continuous months are automatically adjusted by the system.

With the appropriate months to be considered, the user has three options for the analysis. First, the user may opt to have the system automatically run the analysis to determine the combination of drivers that provide the best forecasting result. Second, the user may opt to manually select the drivers to be considered and run the analysis with only the drivers the user selected. For both of these first two options, the user may accept the default of a zero intercept or choose to not force a zero intercept. Third, the user may opt to manually select the drivers and enter the driver factors manually for the forecast.

If a user opts to have the system generate the analysis automatically, the system automatically runs through all contact driver-contact volume analysis combinations and determines the combination of contact drivers that provides the best forecast. If a user opts to run the analysis manually, the system runs through these calculations once for the contact driver-contact volume combination selected by the user.

The result of these first two analysis techniques is the determination of each contact driver's multiplier that is to be used to create the forecast. The third technique allows users to determine these factors on their own and enter them in the system.

Taking the contact driver multiplier and multiplying it by the contact driver volume for the period, the day-of-week scheme percentage associated with that day and any holiday factor(s) in effect for that day, creates the daily base contact forecast. Users may establish new factors by simply selecting a new start date and re-running the analysis with any combination of contact driver-contact volume information.

Generating Related Contact Forecasts

Creating a related contact forecast requires users to select an existing base or response forecast on which the related forecast is based, define the contact handling as discrete or virtual, assign a percentage to the related forecast (this is the percentage that is to be multiplied against the forecast which the related forecast is based) and assign a start date to the related contact forecast. The system automatically calculates the related contact forecast based on these factors during the assigned period. Users may alter the related forecast percentage by entering a new start date and related percentage.

Allocation Forecast

The allocation forecast determines how contacts are to be allocated to skill groups based on the allocation technique selected and the skill groups assigned. It is not necessary for contacts to be assigned an allocation forecast to complete a contact forecast. However, it is necessary to complete an allocation forecast to generate a staffing (FTE staff) forecast.

Prior to establishing any allocation forecast, the user must establish one or more skill groups in the system. Establishing a skill group is accomplished by simply adding a skill group name to the operations view.

Contact Allocation Schemes

Contact allocation schemes define the skill groups assigned to a contact forecast, how the contacts are to be allocated and the technique of allocation. The system supports two techniques of allocation, one as a custom allocation and the second as an allocation by skill group staff levels. The type of allocation technique is independent of the designation of contact forecasts as virtual or discrete.

Custom allocation is one in which the user defines the percentage of total contacts to be assigned to a skill group based on the day of the week (Sunday through Saturday). The sum of all percentages across any day must add up to one hundred percent (to ensure that the full contact volume is allocated). When an allocation scheme using this methodology is applied to a contact forecast (any type of contact forecast can be used), the system multiplies the total contact volume forecasted for a given day by the percent associated with that skill group for that day. This algorithm is repeated across all contact forecast-skill group combinations.

Allocations by skill group staff perform the same algorithm, with an intermediate step to determine the daily proportion a skill group staff is of the total staff of skill groups assigned to the contact forecast. When staffing plans change, the allocations change as well.

Handling Multiple Contact Types Within a Skill Group

The system accounts for skill groups that contain a single contact type or multiple contact types, including mixes of virtual or discrete contacts, contacts with varying handling times, handling times with varying new hire learning curves (to be reviewed later) and contacts with varying service levels.

When a skill group is assigned a single contact type, the parameters (hours of operation for the skill group, number of contacts, handling time, service level goal and efficiency) are used to determine productive staffing levels required to meet the service level goal. When multiple contact types with the same service level goal are discretely assigned to a skill group, the system uses hours of operation, total number of contacts, the calculates a weighted AHT (applying individual learning curves as appropriate), a weighted efficiency and a weighted service level to determine required productive staffing. These are the two simplest examples of contacts assigned to skill groups.

If a skill group is assigned multiple contact types with the same service level goal with some contacts virtually assigned to a skill group, the system takes into account the impact the contacts that are shared with other skill groups when calculating productive staff requirements (to obtain the proper service level-occupancy relationship, the system must take into account the impact of virtually handled contacts). The system uses the hours of operation for that skill group, the total number of contacts including the designated virtual contacts handled by other skill groups, a weighted AHT using just the contacts handled within the skill group (with their associated learning curves), a blended service level based on the individual service levels within that skill group and calculates a weighted efficiency using just the contacts handled within the skill group to determine required productive staffing. If, in this same scenario, some of the contacts have different service level goals, the system automatically selects a common service goal assumption between all contact types, translates the various service level goals to the standard and then calculates the productive staff required to meet the service level goal.

The system performs these calculations for hours of operation, contact volume, handling time, service level goals and efficiency on a daily basis for each skill group. Designation of a contact type as virtual or discrete allocation is taken into consideration when calculating productive hours required through a modified Erlang C equation. The modified Erlang C equation supporting these calculations will be discussed below. Even though those skilled in the pertinent art understand the Erlang equation, a basic discussion of the Erlang equation can be found at http://www.inround.com/articles/primerstaffing.htm, which is incorporated herein by reference.

Operations Forecasting

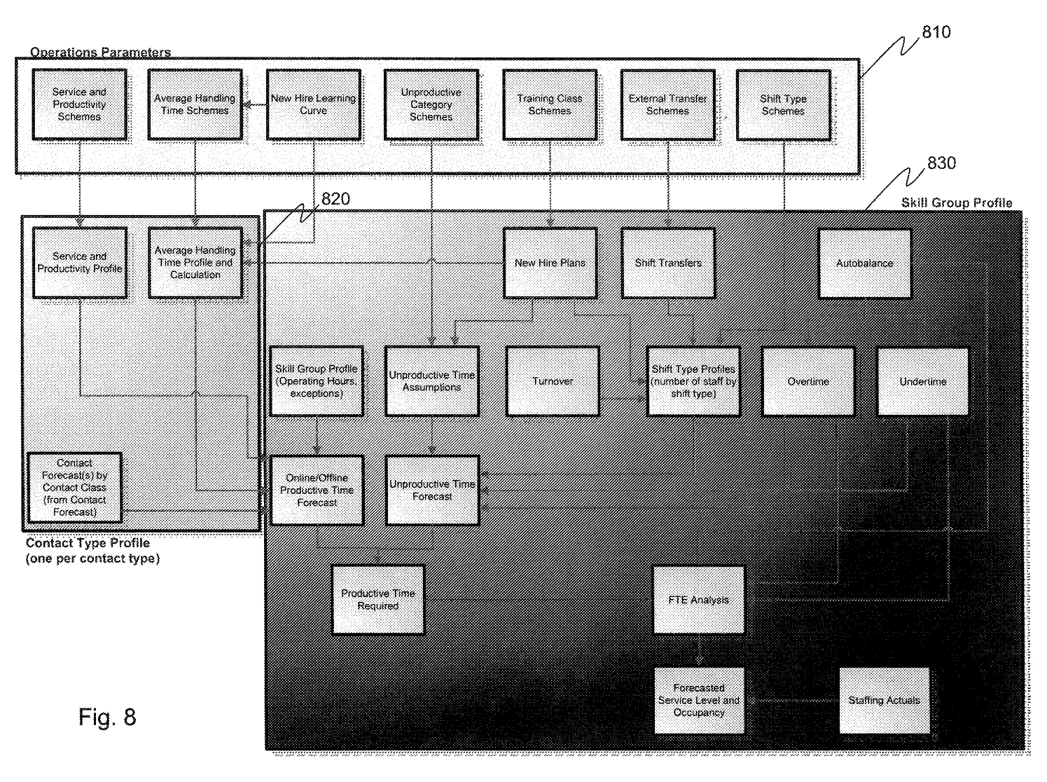

Turning now to FIG. 8, illustrated is a system for operations forecasting that shows the interdependent relationship of the elements that can be used to generate a staffing (FTE) forecast. In the system of FIG. 8, an operations parameters module 810 is used to generate a contact type profile in a contact type profile module 820. The operations parameters module 810 and the contact type profile module 820 are used to generate a skill group profile in a skill group profile module 830.

A contact forecast is required to generate an operations forecast. An operations forecast may be generated for either productive online or offline time only, productive time requirements (productive online/offline and unproductive time), or FTEs required (productive time plus staffing and over/undertime impacts). Operations forecasts can be used to determine the forecasted occupancy and service levels of operations given the contact forecasts, operations parameters and staffing plans.

The operations forecast has a set of operations parameters (called schemes) that can be established at the global level and then applied to each forecast individually (forecasts can then share a set of assumptions, or schemes, if desired). Schemes are set at the global level to ensure consistency in assumptions and applications, and can be controlled by the system administrator, if desired. (In such a case, users would not be able to change market parameters (global assumptions), but only select from a list predetermined by the system administrator.

Contact types are assigned to each skill group through the allocation forecast defined in the contact forecast. Contact types have daily volumes that are associated with each assigned skill group. The skill group supports each contact type according to the contact type parameters established by the user. Each contact type within the operations forecast is required to be defined as being offline (no Erlang C scheme applied) or online (applying an Erlang C scheme with defined service level goals), as well as an efficiency factor. Efficiency is used to increase the accuracy of the forecast. Each contact type also has a defined AHT (each which has an associated new hire learning curve). Each skill group combines the service levels (online only), efficiencies, and AHTs (adjusted with that skill group's new hire plan) to determine the productive time requirements.

With a staffing plan is present, the user may establish an Unproductive Time forecast by inputting a series of assumptions relative to each unproductive category. (Note that if a staffing plan is not present, the user can still establish an Unproductive Time forecast by using a set number of hours per day, unrelated to a staffing plan.) The system allows users to create interdependent relationships between unproductive categories that can adjust other unproductive categories automatically or can be adjusted by other unproductive categories automatically (or not adjusted either way) to recognize that some unproductive activities (e.g., vacation) make FTEs unavailable for other unproductive activities (e.g., breaks).

Staffing plans are seeded with initial values (if desired) and are adjusted by turnover, transfers (in and out) and new hire plans to establish the daily headcount by shift type. Shift types are defined in hours by day such that the hours available are determined by multiplying the shift type hours in a day and the headcount of that shift type and then summing the results across all shift types. Users can also establish overtime and undertime hours to add or subtract hours to the staffed hours. These combined hours determine the available staffed hours, which are then used to project occupancy and service levels.

The system also provides an autobalance function that utilizes overtime and undertime planning (treating any established overtime and undertime hours as minimums and then adding to them as required) to correct staffing plans to meet prescribed staffing goals. The system also provides projected occupancy and service levels based on these adjusted staffed hours.

Generating an operations forecast does not require that both a market forecast and allocation forecast be established beforehand. A user could establish a skill group and not have any productive work assigned to it and simply establish the skill group to manage unproductive time for a given staff. However, in order to assign contact volumes to specific skill groups, both a market and allocation forecast must be completed.

The operations forecast determines productive time requirements, unproductive time requirements and staffing requirements based on information from the market forecast and user input.

Operations Parameters

Like the market forecast, the operations forecast has a set of operating parameters that are established and then can be accessed when developing a skill group profile. These global parameters include:

Service and Productivity Schemes. Users establish a set of service and productivity schemes to later apply service level and productivity goals with a contact type-skill group combination. Users begin by entering the name of the service and productivity scheme profile. They then select whether the contacts are to be managed online (sensitive to service goals) or offline (do not have service goals). If they are offline, the user establishes an efficiency parameter, which determines what percentage of the time staff that is working is actually productive. If online is selected, the user enters a service goal (either an average speed of answer or a service level/service time goal). Service time goals may be entered in seconds, minutes, hours or days. An online efficiency figure is also entered. Online efficiency is the percentage of a strict Erlang C occupancy (an ideal objective) a skill group attains. Efficiency is used within the revised Erlang formula, which will be discussed later in this document.

AHT Schemes. AHT schemes are later applied to specific contacts within a skill group. AHT schemes may be entered either as being constant within a week (the same figure each day of the week) or varying by day of the week. Users also enter in the new hire learning curve associated with a handling time profile. New hire learning curves are entered as a percentage premium over the designated handling time based on the number of weeks since training has been completed. Handling time premiums are applied only to the new hires within the learning curve. AHT within a contact type-skill group combination are determined daily based on the number of new hires, the weeks since training was completed and the number of people on staff. The specifics of AHT calculations within a skill group will be discussed in more detail later.

Unproductive Category Schemes. Unproductive category schemes are provided to allow users to establish and track unproductive time in the level of desired detail. Users establish an unproductive category name and then can associated various unproductive category time names (allowing for one or more times names to be associated with one category name). Each time name is designated as paid or unpaid, which is taken into consideration within the skill group.

Training Class Schemes. The training class schemes established the length of training, in days or weeks that is later assigned to a specific shift type. Training class schemes are established by entering a name, start date, selecting the time period for the duration (days or weeks) and the number to be associated with the training. The length of training may change over time by adding a new start date to a training class scheme profile.

External Transfer Schemes. External transfer schemes are established to allow users to make adjustments to their staffing plan by moving people in and out of the skill group without having to impact turnover, new hire staffing or training. When an external transfer scheme has been established, it can be used to increment or decrement staff from any shift type within a skill group.

Shift type Schemes. A shift type is defined as the number of hours per day assigned to a shift name in a week. A shift name is a designation provided by the user to provide a unique identifier to each shift type. To create a shift type scheme, a user enters the shift type name, a start date and the length, in hours, of the shift for each day of the week. The user can change the associated hours in a shift by entering in a new start date. Shift type schemes are used in the system to help determine available staff and can be used by the system in determining unproductive time allocations, turnover and new hire applications.

Generating Operations Forecasts

Operations forecasts can be generated at a variety of levels, depending on the depth of information required by the user. A user can generate a forecast for productive needs only, in which case they need only complete parameters for service and production assumptions and AHT assumptions. Users may develop a staffing requirement scheme without a staffing scheme by completing a productive time needs forecast and entering unproductive time as a set number of hours per day. Users may also complete a full staffing analysis to include productive time requirements, unproductive time requirements and staffing requirements. To accomplish this level of staff forecasting, shift type names and unproductive category names must be completed.

Assuming an allocation scheme has already been established, the user has already set up at least one skill group name. Like the market forecast, the operations forecast allows users to establish a structure creating a series of relationships that provide users the ability to run summary reports easily. The structure is independent of the market structure created, although the system shows what contact types are associated with each skill group.

Once a skill group has been established (named and placed in the operations structure), the user establishes a profile for the skill group that defines the effective date of the skill group (note that the effective date is either the date the skill group was formed or the date that the forecast for the skill group begins, which ever is later) and the hours of operation by day. If operating hours for the skill group changes, the user enters a new start date for those hours. The new start date signals the system to place an end date on the previous operating hour profile and to use the new profile from the start date until a new start date is encountered. Users may enter exceptions to the operating hours for specific dates, including pre-designated holidays. Once the skill group profile is established, the system refers to this information in its productive time calculations. In addition, the system recognizes days in which the skill group is not open and creates an error message for users should contact volume be allocated to the skill group on that day.

With the skill group profile completed, the user completes information on each contact type assigned to the skill group. Contact setup information includes the AHT scheme (which has an inherent new hire learning curve scheme associated with it), the service and productivity scheme associated with the contact type and the start date for which the information is applied. New schemes can be applied by creating a new start date. Contact types within a skill group may have different AHT schemes and service and productivity schemes. The same contact type that is assigned to different skill groups may have a different combination of AHT schemes and service and productivity schemes.

With the skill group profile and contact profile established, a productive staffing analysis can be run. Productive staffing analysis determines the number of productive hours that are required to handle online and offline contacts with their respective profiles (service levels and efficiencies). Before productive staffing analysis can be completed, the system first combines the profiles of all contact types at the skill group level to provide an appropriate forecast. Specifically, the system provides a combined number for contact volume, AHT and efficiency. Contact volumes are computed by summing the contacts by type (offline and online).

AHTs for a contact type are calculated by day, taking into account the assigned AHT and adjusting it for the impact of new hires. The AHT for a contact type within a skill group is determined by taking the total staffed hours and dividing that by the sum of the ratio of new hire scheduled hours divided by their adjusted handling time (the assigned handling time times one plus the new hire premium for that day) and the ratio of non-new hire scheduled hours divided by the AHT assigned to that profile. This approach allows each contact type to have a unique AHT each day, depending on the staffing mix. AHTs for a skill group are calculated by taking a weighted average of all contacts and their associated handling times for each day.

Skill group efficiencies are calculated by taking the summing combined contact volume and handling time (contacts times handling time) by contact type and dividing it by the sum of the combined contact volume, handling time and efficiency (contacts times handling time times efficiency). Separate calculations are made for online and offline contact types. All calculations are performed on a daily basis.

The system calculates offline production requirements by taking the sum of all offline contact volumes by day, multiplying it by the associated calculated AHT for all offline contacts and dividing this product by the calculated efficiency for offline contacts in the skill group.

Online productive time calculations require the system to recognize if contacts are shared with other skill groups on a virtual basis. If they are not, the system calculates productive time based on a modified Erlang C calculation using the total contacts, AHT as calculated for all online contacts and the average efficiency for all online contacts. If some contacts within the skill group are virtual and shared with other contact groups, the system adds the virtual contacts from the other skill groups into the modified Erlang C calculation. If online contacts within a skill group have different service level time goals, the system uses the modified Erlang C calculation to first bring service levels to an equivalent goal (if service goals are a combination of service level and service time, the system uses service time to determine the percent service goal for each contact type or a weighted average speed of answer if goals are expressed in those terms, otherwise a weighted average speed of answer is determined based on contact volume). After bringing service goals to an equivalency, the productive time calculations are completed as previously described in this paragraph.

For example, a skill group has three contact types associated with it. Contact A has an AHT of 300 seconds with no new hire impact and a service level goal of 90% of contacts handled in 20 seconds. Contact B has an AHT of 200 seconds with no new hire impact and a service level goal of 90% of contacts handled in 30 seconds. Contact C is the largest volume of the three, has an AHT of 300 seconds, a new hire impact of 10 seconds the first day and a service level goal of 80% of contacts handled in 30 seconds. All three contact types have the same efficiency of 94%. Contact A, B or C is not designated as being virtually routed with any other skill groups.

The system first sets all service level time goals at 60 seconds. Contact A's service level goal would be adjusted on a basis of 30 seconds, say 95% in 30 seconds. The system then uses a weighted average based on the contact volume of each to determine a targeted % to be answered in 30 seconds, say 83%. (The percent goal likely changes daily based on the daily contact volume mix of each of the three contact types.) The system then calculates the Erlang workload based on the contact volumes and handling times of each. Note that the AHT for Contact C is adjusted upward to account for the new hire impact on this day.

The system calculates productive staff requirements for these three contact types based on the total contact volume, the weighted AHT, the adjusted service level (83% of contacts answered in 30 seconds), a weighted average efficiency (in this case they are all the same, 94%) and the operating hours of the skill group.

The modified Erlang C calculation is an enhanced version of the standard Erlang C equation. The standard Erlang C equation uses exponentials and factorials, which make calculations for medium and large skill groups unwieldy, inefficient and at times exceeding the capabilities of systems. The first modification to the Erlang C equation is to reduce the equation to provide more efficient calculation and avoid the large number limitation.

The second modification to the Erlang C equation is to include a factor, called “efficiency,” into the equation. The inclusion of an efficiency factor in the equation modifies the standard Erlang C calculation to included factors that are applicable to the contact center environment (e.g., imperfect schedules, imperfect adherence, imperfect forecasts). The inclusion of efficiency reflects real world contact center operations to provide a more accurate forecast.

The third modification to the Erlang C equation is the use of an interpolation function to increase the precision of the equation and provided non-integer results.

The system adds the online and offline productive time to determine the total productive time requirements. Should users wish to develop an unproductive time forecast, they should have filled out the shift type scheme and the unproductive time scheme (if the unproductive time forecast will be dependent on staffing).

Developing an unproductive time forecast requires a user establish an active set of shift types for the skill group (unless the unproductive time forecast is a set number of hours per day independent of staffing). Establishing shift types begins by setting a start date and selecting a shift type that was established in the shift type Scheme. Users may establish multiple shift types for each skill group. Users also have the option of establishing a set of initial assumptions (seed values) for each shift type. Initial assumptions are normally used when a skill group has been established prior to the forecast. The inputs provide staffing values that feed the staffing plan beginning on the start date of the analysis.

With a staffing plan in place, users enter the assumptions for unproductive time categories. Users select an unproductive category from the list that was generated in the unproductive category scheme. Users select a start date and may enter data by shift type (new hires for each shift type can be included separately, if desired), apply the assumptions across all shift types, enter figures as a percentage of total scheduled hours (e.g., 5.25% across all shift types), enter figures as a number of hours (e.g., 0.25 hours for part time, 0.50 hours for eight hour full time, 0.75 hours for ten hour full time) or enter a fixed number of hours per day without considering scheduled hours or shifts.

Entries are made by day-of-week. Users may enter exceptions to specific days to override unproductive time assumptions on those days (for example, to make exceptions for holidays). New assumptions can be established by entering a new start date.

Unproductive time can be designated as having one of three roles. An unproductive time category can be designated as having an impact on other unproductive categories. For example, if a person were taking a vacation day, while they would be scheduled and paid, they would not be available for activities occurring onsite. Designating an unproductive time category in this way allows the system to make adjustments to other unproductive categories when unproductive time is forecasted.

Unproductive time may also be designated as being impacted by other unproductive categories. For example, if a user is forecasting breaks, they may want to make adjustments for scheduled people who are on vacation so as not include them in their forecast.

The third category of unproductive time is one that does not impact, nor impacts, other unproductive time categories. An example of this would be a receptionist position, where a specific amount of time is spent at that position away from designated productive time. This administrative time should be allocated regardless of vacations, breaks, etc.

When calculating total unproductive time, the system takes into account the relationships between unproductive categories, as well as overtime and undertime plans (recognizing that overtime and undertime may impact unproductive time). The system includes overtime and undertime in its scheduled time, adjustments are made to unproductive times based on the level of overtime and undertime for each day. If the user selects the autobalance feature of the system (to be described later), the system's adjustments to overtime and undertime impact unproductive time calculations, which then impact the overtime and undertime necessary to reach the autobalance goals. The autobalance feature requires several iterations to be made by the system to settle on a precise figure for the impacted by and impacts unproductive categories.

With the productive and unproductive times calculated by the system, the user is provided with the total time required to meet the forecasted plan. Users can enter additional parameters, such as a hiring plan, turnover plan and shift transfer plan to provide a full staffing forecast. Note that transfers do not impact AHT calculations and only impact available staff.

The user may also enter an overtime plan and/or undertime plan (the two plans are separate) to reflect their plans for the operations. Each of these elements has the ability to forecast by shift type, has the option of including new hires and can change its assumptions through the use of a new start date.

With this information, the system provides users with a staffing forecast. The system provides daily, weekly or monthly feedback on the level of staffing (overstaffing or understaffing) and the forecasted service goal attainment given the current plan. The system also provides information on the service goal attainment and occupancy achievement if no overtime or undertime is used in the plan.

The system also has the ability to automatically balance overtime and undertime to a specific overstaffing or understaffing goal set by the user (balanced staffing is defined as zero overstaffing or understaffing). The system assumes that any overtime or undertime already established in the forecast by the user establishes a minimum for overtime or undertime for a day (the system allows both overtime and undertime to exist in a day) and that any adjustments necessary to meet service goals add to the overtime (if additional staffing is needed) or added to the undertime (if less staffing is needed). The system then reports the total overtime and undertime required on each day (required being that which the user included in the forecast plus any amount added in the autobalance function). As mentioned previously, autobalance causes the system to make several passes to account for the relationship between staffing (including overtime and undertime) and unproductive time (impacted by and impacting) categories.

With the completion of these final inputs and functions, the system provides users with a completed staffing forecast. Elements of the staffing forecast can then be imported to a WFM system.

Although the invention has been described in detail, those skilled in the pertinent art should understand that they can make various changes, substitutions and alterations herein without departing from the spirit and scope of the invention in its broadest form.

What is claimed is:

1. A system for providing daily and long-term contact,
allocation and full-time equivalent staff forecasting, comprising:
a first module configured to generate a forecast of overall volume based on contacts disaggregated by type;
a second module associated with said first module and configured to simulate an allocation of contacts to skill groups; and
a third module associated with said first and second modules and configured to generate a full-time equivalent staff forecast based on service time, staffing efficiency, unpaid time and said forecast of overall volume.

2. The system as recited in claim 1 wherein said system is further configured to employ response curves, day-of-week factors, holiday factors, response rates and delayed response periods to generate said forecast of overall volume.

3. The system as recited in claim 1 wherein said system is further configured to use contact drivers in association with contact volumes to generate said forecast of overall volume.

4. The system as recited in claim 3 wherein said system is further configured to adjust beginning of period and end of period for said contact drivers.

5. The system as recited in claim 3 wherein said contact drivers are configured to be adjusted over time to increase analytical accuracy.

6. The system as recited in claim 1 wherein said contacts are disaggregated into components of base contact volume, response contact volume and related contact volume using historical information.

7. The system as recited in claim 1 wherein said system is further configured to apply holiday factors to days without requiring user intervention.

8. The system as recited in claim 1 wherein said system is further configured to use adjusted historical data to compute first time contacts based on user-input retry rates.

9. The system as recited in claim 1 wherein said system is further configured to adjust equivalent monthly contacts into equivalent weekly contacts based on the number and type of days in a month, including holiday impacts.

10. The system as recited in claim 1 wherein said system is further configured to compute base contact forecasts using non-seasonal analysis.

11. The system as recited in claim 1 wherein said system is further configured to compute base contact forecasts using seasonal analysis.

12. The system as recited in claim 1 wherein said system is further configured to relate contact forecasts to one another.

13. The system as recited in claim 1 wherein said system is further configured to designate contacts as virtually or discretely allocated to skill groups.

14. The system as recited in claim 1 wherein said system is further configured to allocate contacts to skill groups using set allocation factors or varying allocation by day according to staffing plans.

15. The system as recited in claim 1 wherein said system is further configured to differentiate between online and offline productive activities.

16. The system as recited in claim 1 wherein said system is further configured to calculate an average handling time based on a learning curve and a new hire plan associated with each new hire tenure.

17. The system as recited in claim 1 wherein said system is further configured to handle unequal service levels for contacts in a same skill group to calculate productive staff requirements.

18. The system as recited in claim 1 wherein said system is further configured to take virtually routed contacts with another skill group into account in a modified Erlang C calculation within a skill group.

19. The system as recited in claim 1 wherein said system is further configured to apply forecasting and staffing efficiency to adjust Erlang C calculations.

20. The system as recited in claim 1 wherein said system is further configured to determine unproductive time by defining categories that can impact one another, be impacted by one another and have no impact.

21. The system as recited in claim 1 wherein said system is further configured to override operating hours, unproductive time and other assumptions for special days as designated by the user.

22. The system as recited in claim 1 wherein said system is further configured to establish minimum undertime and overtime values or rates daily.

23. The system as recited in claim 1 wherein said system is further configured to determine overtime or undertime requirements, based on user parameters, to reach service and productivity goals.

24. The system as recited in claim 1 wherein said system is further configured to transfer staff without impacting average handling time.

25. A method of providing daily and long-term contact, allocation and full-time equivalent staff forecasting, comprising:
generating a forecast of overall volume, service time and staffing efficiency based on contacts disaggregated by type; and
generating a full-time equivalent staff forecast based on said forecast of overall volume, service time and staffing efficiency.

26. The method as recited in claim 25 further comprising employing response curves, day-of-week factors, holiday factors, response rates and delayed response periods to generate said forecast of overall volume, service time and staffing efficiency.

27. The method as recited in claim 25 further comprising using contact drivers in association with contact volumes to generate said forecast of overall volume, service time and staffing efficiency.

28. The method as recited in claim 25 further comprising adjusting said contact drivers over time periods omitted to increase analytical accuracy.

29. The method as recited in claim 25 further comprising disaggregating said contacts into components of base contact volume, response contact volume and related contact volume using historical information.

30. The method as recited in claim 25 further comprising applying holiday factors to days without requiring user intervention.

31. The method as recited in claim 25 further comprising using adjusted historical data to compute first time contacts based on user-input retry rates.

32. The method as recited in claim 25 further comprising adjusting equivalent monthly contacts into equivalent weekly contacts based on the number and type of days in a month, including holiday impacts.

33. The method as recited in claim 25 further comprising computing base contact forecasts using non-seasonal analysis.

34. The method as recited in claim 25 further comprising computing base contact forecasts using seasonal analysis.

35. The method as recited in claim 25 further comprising relating contact forecasts to one another.

36. The method as recited in claim 25 further comprising designating contacts as virtually or discretely allocated to skill groups.

37. The method as recited in claim 25 further comprising allocating contacts to skill groups using set allocation factors or varying allocation by day according to staffing plans.

38. The method as recited in claim 25 further comprising differentiating between online and offline productive activities.

39. The method as recited in claim 25 further comprising calculating average handling time based on a mix of individual contact handling times, a learning curve associated with each individual contact handling time and a new hire tenure.

40. The method as recited in claim 25 further comprising handling unequal service levels for contacts in a same skill group to calculate productive staff requirements.

41. The method as recited in claim 25 further comprising taking virtually routed contacts with another skill group into account in a modified Erlang C calculation within a skill group.

42. The method as recited in claim 25 further comprising applying forecasting and staffing efficiency to adjust Erlang C calculations.

43. The method as recited in claim 25 further comprising determining unproductive time by defining categories that can impact one another, be impacted by one another and have no impact.

44. The method as recited in claim 25 further comprising overriding operating hours, unproductive time and other assumptions for special days as designated by the user.

45. The method as recited in claim 25 further comprising establishing minimum undertime and overtime values or rates daily.

46. The method as recited in claim 25 further comprising determining overtime or undertime requirements, based on user parameters, to reach service and productivity goals.

47. The method as recited in claim 25 further comprising transferring staff without impacting average handling time.
